(19) United States
(12) Patent Application Publication
(10) Pub. No.: US 2009/0183592 A1
(43) Pub. Date: Jul. 23, 2009

(54) Chain drive transmission, propelled by bent and prolonged levers - configurable mechanism

(76) Inventor: Stefan Zelinka, Sarasota, FL (US)

Correspondence Address: Stefan Zelinka, 3233 Beneva RD # 203, Sarasota, FL, 34232, US

(21) Appl. No.: 12/313,042

(22) Filed: Nov. 18, 2008

(30) Foreign Application Priority Data
Jul. 1, 2002 (SK) P02 1657-93
Jul. 1, 2002 (SK) P02 178919

(51) Int. Cl. B62M 3/02

(52) U.S. Cl. 74/594.3

(57) ABSTRACT

A configurable chain drive transmission, which is propelled by two bent, prolonged, and extendable levers, that can be attached on to an existing chain drive transmission found on bicycles, wheelchairs, carts, and other forms of transportation to increase its output and usefulness.

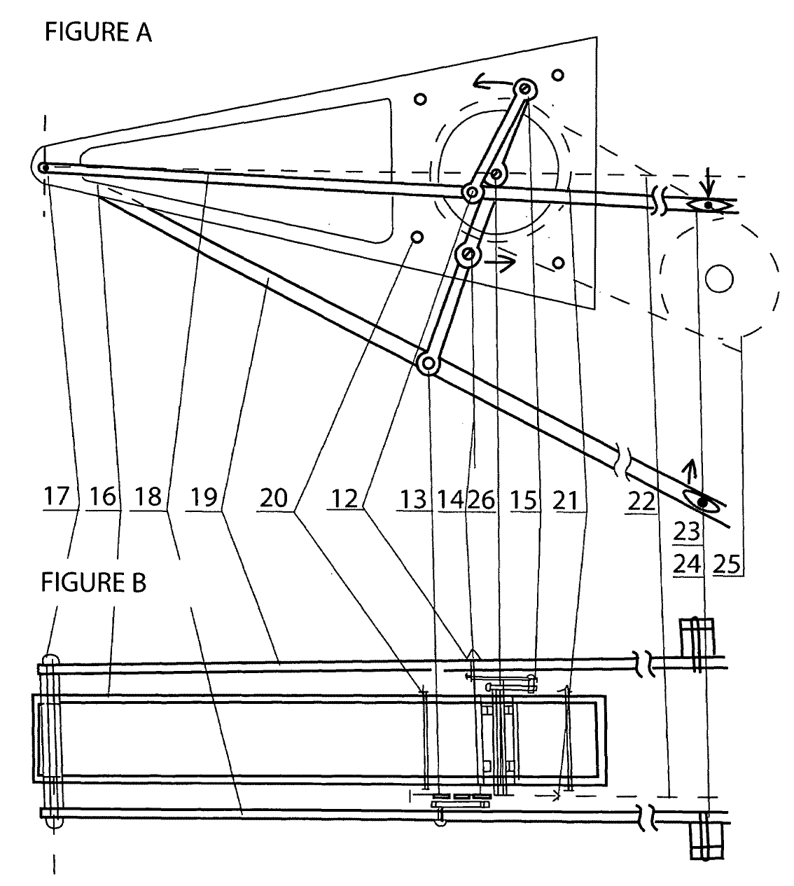

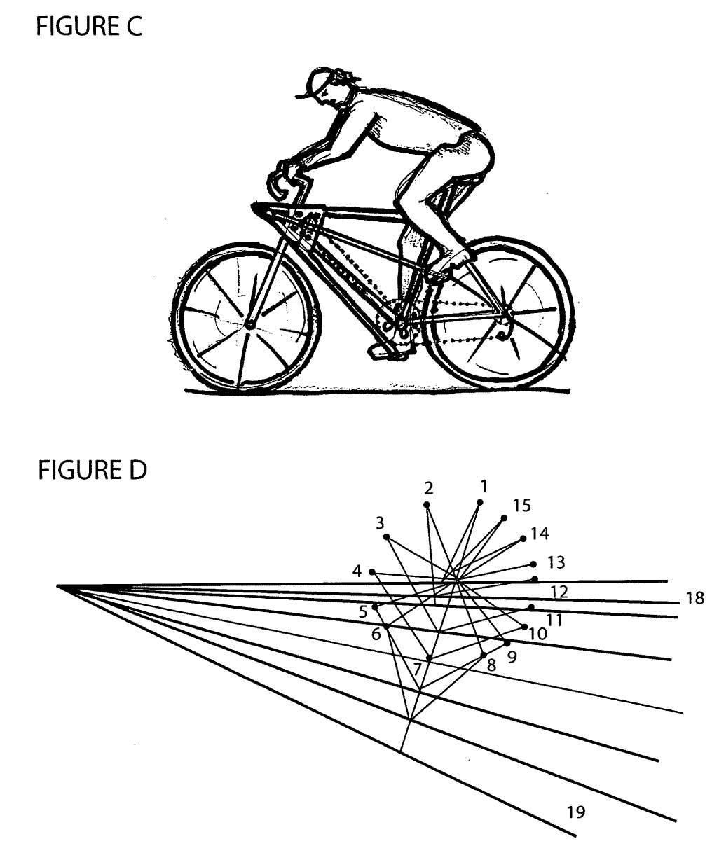

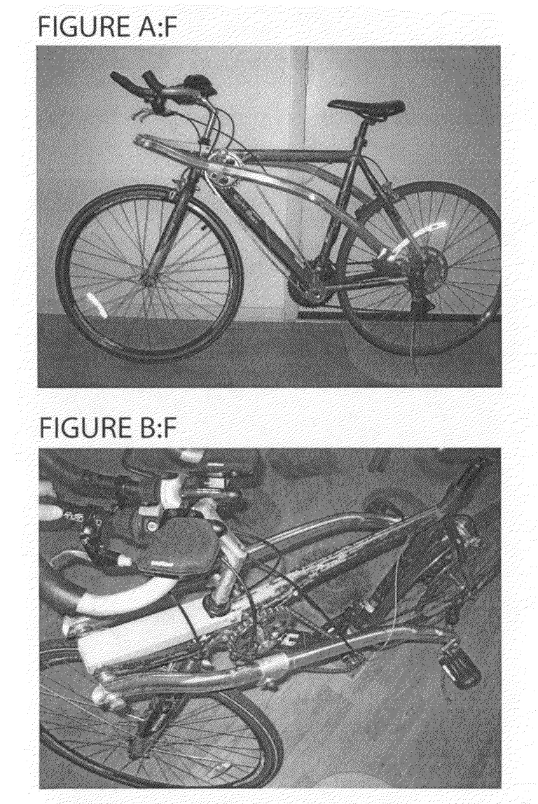

### CURRENT STATE OF THE TECHNIQUE

In current bicycles, and other forms of transportation with a chain drive transmission, the front levers are confined by their length on one side by the ground and on the other due to the limbs of the user, in which the transfer of force is limited and the levers are limited by their length.

### ESSENCE OF THE TECHNICAL SOLUTION OF THE INVENTION

This system heightens the usefulness of today's chain drive transmissions by multiplied prolongation of both levers, whose length can be modified by need, which results in at least two times the weight of the gear ratios in setups in which this configurable mechanism is installed.

The prolonged extendable levers are hanged fulcrumed on the fixed frame, which has the classic chain drive transmission, that is comprised of a sprocket/bolster fixed shaft, on which there will be installed from both sides the fulcrumed bent levers. The longer part of the bent levers is mounted on the prolonged extensible lever, which through pressure rotates the crank that in turn rotates the chain which rotates the crank of a different mechanism.

Zero point of rotation of the crank is solved by the fulcrumed bent levers, through which the fundamental principle is correct, that with the prolongation of the extended levers there are also longer fixed halves with fulcrumed bent levers, whose length must be bigger than the radius of the circle, that account for the joint bent crank. The crank turns in both sides; it depends on which side the pressure is going on to the longer extendable lever.

The output is magnified two times through the gear—a 22 tooth crank turns a 11 tooth crank on a different mechanism such as the bicycle.

### EXAMPLE OF A REALIZATION OF THE INVENTION

Chain drive transmission and bent and prolonged levers are a configurable mechanism according to picture 1, that has the main frame (Figure A:16), which is stabilized by a screw (Figure A:20) for the frame of the bicycle.

In the main frame (Figure A:16) on the pivot located are the hanged prolonged extendable levers (Figure A:18, Figure A:19). In the main frame the chain drive transmission is also imbedded from the bicycle, which comprises of a crank (Figure A:21), mounted on screws of the convertor (Figure A:26), and on both sides the bent levers are mounted (Figure A:14, Figure A:15). The longer parts of the bent levers are mounted in Figure A:13 and Figure A:12 on the extendable levers, on which there are pedals (Figure A:23, Figure A:24) configurable according to the height of the user, who through downward pressure leads the prolonged levers (Figure A:18, Figure A:19) into movement and this through the bent levers of the chain drive transmission rotates the crank (Figure A:21), which puts the chain drive transmission of the bicycle (Figure A:25) into movement with the help of the crank mounted on the left side of the pivot of the chain drive transmission of the bicycle.

### THOUGHT OUT VISUALIZATION

The point is focusing on the usefulness of the invention and its possible uses for the chain drive transmissions of bicycles, carts, boats, planes, and other forms of transportation.

The benefits are that by lengthening the extendable lever you can use more limbs, for example in wheel chairs for the handicapped, which commutes to bigger dispensation of mechanisms.

This mountable mechanism can also be added to another mechanism that is different, without touching the construction of, for example, a bicycle.

The mechanism can also be used as a single machine, for example as a cable pulley.

### DESCRIPTION OF DRAWINGS

Figure A

Side view of the “Chain Drive Transmission, Propelled by Bent and Prolonged Levers—Configurable Mechanism” invention.
12. Bolt for holding in place the bent lever #1.
13. Bolt for holding in place the bent lever #2.
14. Bearing holding in place bent lever #1.
15. Bearing holding in place bent lever #2.
16. Frame.
17. Pivot for levers to hold them in place.
18. Lever #1.
19. Lever #2.
20. Bolt for holding together the frame.
21. Crank—32-tooth.
22. Chain.
23. Pedal #1.
24. Pedal #2.
25. Crank—16-tooth.
26. Pivot of the convertor (located in center of crank).

Figure B
Top view of the “Chain Drive Transmission, Propelled by Bent and Prolonged Levers—Configurable Mechanism” invention.
12. Bolt for holding in place the bent lever #1.
13. Bolt for holding in place the bent lever #2.
14. Bearing holding in place bent lever #1.
15. Bearing holding in place bent lever #2.
16. Frame.
17. Pivot for levers to hold them in place.
18. Lever #1.
19. Lever #2.
20. Bolt for holding together the frame.
21. Crank—32-tooth.
22. Chain.
23. Pedal #1.
24. Pedal #2.
25. Crank—16-tooth.
26. Pivot of the convertor (located in center of crank).

Figure C

Illustration of person riding bicycle with the “Chain Drive Transmission, Propelled by Bent and Prolonged Levers—Configurable Mechanism” invention installed.

Figure D

Montage illustration of the levers from the “Chain Drive Transmission, Propelled by Bent and Prolonged Levers—Configurable Mechanism” invention in movement. If the left lever is pressed down then the movement starts at number 1 and ends with number 15, or the other way around if the right lever is pressed down.

Figure A:F

Photo of the prototype created by the author.

Photo showing the side view of the prototype of the “Chain Drive Transmission, Propelled by Bent and Prolonged Levers—Configurable Mechanism” invention installed on a bicycle by the author.

Figure B:F

Photo of the prototype created by the author.

Photo showing the top view of the prototype of the “Chain Drive Transmission, Propelled by Bent and Prolonged Levers—Configurable Mechanism” invention installed on a bicycle by the author.

I claim:

1. The chain drive transmission, powered by the bent and prolonged levers is a configurable mechanism that is comprised of the main frame (Figure A:16), which is mounted with screws (Figure A:20) on to the bicycle frame. On the main frame on the screws (Figure A:17) there are hanged the prolonged extendable levers (Figure A:18, Figure A:19), which are connected with the bent levers of the convertor in Figure A:12 and Figure A:13, and these are fixed on the screws of the convertor (Figure A:26), on which there is mounted the crank (Figure A:21).

2. The bent levers (Figure A:14, Figure A: 15) consist of two hangers, through which the longer hanger is mounted on the extendable prolonged lever in Figure A:12 and Figure A:14 through which their length is bigger than the radius of the circle, which designates the shorter hangers of the bent levers.

3. On the prolonged levers there are mounted pedals (Figure A:23, Figure A:24), which are configurable according to the physical attributes of the user.

4. This chain drive transmission is connected to a different chain drive transmission mechanism (Figure A:22) on the left side of the crank (Figure A:25).
